(19) United States
(12) Patent Application Publication
(10) Pub. No.: US 2017/0272716 A1
(43) Pub. Date: Sep. 21, 2017

(54) PROJECTION APPARATUS, PROJECTION CONTROL METHOD, AND STORAGE MEDIUM

(71) Applicant: CASIO COMPUTER CO., LTD., Tokyo (JP)

(72) Inventors: Atsushi NAKAGAWA, Tokyo (JP); Ryoichi FURUKAWA, Hamura-shi (JP)

(73) Assignee: CASIO COMPUTER CO., LTD., Tokyo (JP)

(21) Appl. No.: 15/382,191

(22) Filed: Dec. 16, 2016

(30) Foreign Application Priority Data
Mar. 15, 2016 (JP) 2016-051253
May 24, 2016 (JP) 2016-103396

(51) Int. Cl. H04N 9/31

(52) U.S. Cl. CPC H04N 9/3185

(57) ABSTRACT

A projection apparatus includes an input unit configured to input an image signal, a projection unit configured to project an image corresponding to the image signal, an attitude sensor configured to detect an attitude around a projection optical axis of the projection unit in which the projection apparatus is installed, and a projection control unit configured to project, when the attitude detected by the attitude sensor falls within a predetermined range, the image under a first projection condition, and project, when the attitude detected by the attitude sensor falls outside the predetermined range, the image under a second projection condition different from the first projection condition.

### CROSS-REFERENCE TO RELATED APPLICATIONS

This application is based upon and claims the benefit of priority from Japanese Patent Applications No. 2016-051253, filed Mar. 15, 2016; and No. 2016-103396, filed May 24, 2016, the entire contents of all of which are incorporated herein by reference.

### BACKGROUND OF THE INVENTION

1. Field of the Invention

The present invention relates to a projection apparatus, a projection control method, and a storage medium, preferable for a projector or the like which copes with the portrait and landscape states of an apparatus housing.

2. Description of the Related Art

Jpn. Pat. Appln. KOKAI Publication No. 2012-137707 proposes the technique of a projection-type video display device capable of adjusting the tilt of a housing in either of the landscape and portrait states, and attempting to simplify an arrangement for adjusting the tilt of the housing. By including the technique described in Jpn. Pat. Appln. KOKAI Publication No. 2012-137707, many projection apparatuses which cope with the use of the housing in the portrait/landscape state have a function of automatically correcting the vertical direction of an image to be projected.

In general, when the attitude of the housing of a projection apparatus is changed during an operation of performing projection, it is considered that, in addition to the vertical direction of the projection image, other projection environments, for example, an external apparatus such as a personal computer for inputting an image signal, a projection target screen, and the like often change at the same time.

When the projection environments other than the vertical direction of the projection image change, even if the apparatus automatically corrects the vertical direction of the projection image, the user needs to manually change the settings and the like of other projection environments every time.

Under the circumstances, it is desired to provide a projection apparatus, a projection control method, and a storage medium, capable of continuing an optimum projection operation in response to a change in projection environment without requiring the user to perform complicated setting operations.

### SUMMARY OF THE INVENTION

According to one aspect of the present invention, there is provided a projection apparatus comprising: an input unit configured to input an image signal; a projection unit configured to project an image corresponding to the image signal; an attitude sensor configured to detect an attitude around a projection optical axis of the projection unit in which the projection apparatus is installed; and a projection control unit configured to project, when the attitude detected by the attitude sensor falls within a predetermined range, the image under a first projection condition, and project, when the attitude detected by the attitude sensor falls outside the predetermined range, the image under a second projection condition different from the first projection condition.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram mainly showing the functional arrangement of the electronic circuits of a projector apparatus according to an embodiment of the present invention;

FIG. 2 is a flowchart illustrating the processing contents of a projection operation according to an attitude, which is executed by a CPU in the first operation example according to the embodiment;

FIGS. 3A and 3B are perspective views of the outer appearance exemplifying changes in projection contents and attitude of the projector apparatus in the first operation example according to the embodiment;

FIG. 4 is a flowchart illustrating processing contents according to an attitude change, which is executed by the CPU in the second operation example according to the embodiment; and

FIGS. 5A and 5B are perspective views of the outer appearance exemplifying changes in projection contents and attitude of the projector apparatus in the second operation example according to the embodiment.

### DETAILED DESCRIPTION OF THE INVENTION

An embodiment of a case where the present invention is applied to a projector apparatus will be described in detail below with reference to the accompanying drawings.

### Arrangement

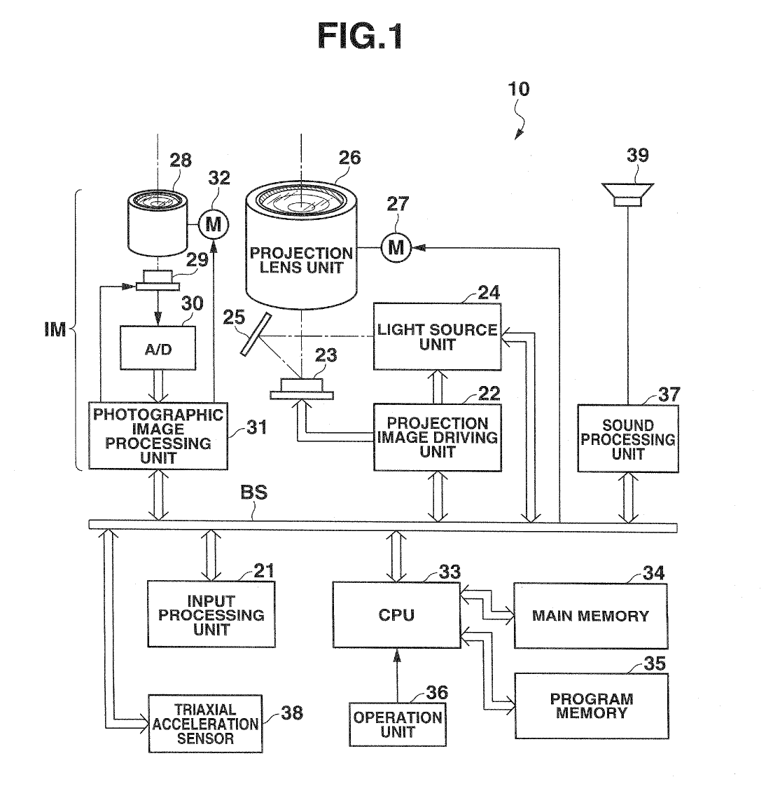

FIG. 1 is a block diagram mainly showing the functional arrangement of the electronic circuits of a projector apparatus (projection apparatus) 10 according to this embodiment. Referring to FIG. 1, image data input to an input processing unit 21 is digitized in the input processing unit 21, as needed, and then sent to a projection image driving unit 22 via a system bus SB. Projection systems (projection units) 22 to 27 include the projection image driving unit 22, a micromirror element 23, a light source unit 24, a mirror 25, a projection lens unit 26, and a lens motor (M) 27.

In accordance with the sent image data, the projection image driving unit 22 performs display driving of the micromirror element 23 serving as a display element by higher-speed time division driving by multiplying a frame rate according to a predetermined format, for example, 120 [frames/sec] by the division number of color components and a display gradation number.

The micromirror element 23 performs a display operation by quickly turning on/off each of the tilt angles of a plurality of micromirrors arranged in an array, for example, micromirrors for WXGA (1,280 pixels in the horizontal direction×800 pixels in the vertical direction), thereby forming an optical image using the reflected light.

On the other hand, the light source unit 24 cyclically, time-divisionally emits primary color light beams of R, G, and B. The light source unit 24 includes an LED as a semiconductor light-emitting diode, and repeatedly, time-divisionally emits the primary color light beams of R, G, and B. The LED of the light source unit 24 may include an LD (semiconductor laser) or organic EL element, as an LED in a wide sense. The primary color light from the light source unit 24 is totally reflected by the mirror 25, and the micromirror element 23 is irradiated with the light.

An optical image is formed by the light reflected by the micromirror element 23, and then projected and displayed outside via the projection lens unit 26.

The projection lens unit 26 includes, in a lens optical system, a focus lens for moving a focus position and a zoom lens for changing a zoom (projection) view angle, and the positions of these lenses along an optical-axis direction are selectively driven by the lens motor (M) 27 via a gear mechanism (not shown).

On the other hand, the present invention provides a photographic unit IM for performing photographing in a projection direction in the projection lens unit 26. This photographic unit IM includes a photographic lens unit 28. This photographic lens unit 28 includes a focus lens for moving a focus position, and has a photographic view angle to cover a projection view angle at which light exits when the projection lens unit 26 is set to have a widest angle. An external optical image entering the photographic lens unit 28 is formed on a CMOS image sensor 29 serving as a solid-state image sensor.

An image signal obtained by image formation in the CMOS image sensor 29 is digitized in an A/D converter 30, and then sent to a photographic image processing unit 31.

This photographic image processing unit 31 performs scanning driving of the CMOS image sensor 29 to execute a photographic operation, thereby performing image processing such as histogram extraction for each primary color component of image data obtained by photographing. In addition, the photographic image processing unit 31 drives a lens motor (M) 32 for moving the focus lens position of the photographic lens unit 28.

A CPU 33 controls all of the operations of the above circuits. This CPU 33 is directly connected to a main memory 34 and a program memory 35. The main memory 34 is formed by, for example, an SRAM, and functions as a work memory for the CPU 33. The program memory 35 is formed by an electrically rewritable nonvolatile memory, for example, a flash ROM, and stores operation programs executed by the CPU 33, various kinds of standard data, and the like.

The CPU 33 reads out the operation programs, the standard data, and the like stored in the program memory 35, loads and stores them in the main memory 34, and executes the programs, thereby comprehensively controlling the projector apparatus 10.

The CPU 33 executes various projection operations in accordance with operation signals from an operation unit 36. This operation unit 36 includes a light-receiving unit for receiving an infrared modulation signal from an operation key included in the main body housing of the projector apparatus 10 or a remote controller (not shown) dedicated for the projector apparatus 10, and accepts a key operation signal and sends a signal corresponding to the accepted key operation signal to the CPU 33.

The CPU 33 is also connected to a sound processing unit 37 and a triaxial acceleration sensor 38 via the system bus SB.

The sound processing unit 37 includes a sound source circuit such as a PCM sound source, and converts, into an analog signal, a sound signal provided at the time of a projection operation, and drives a speaker 39 to output a sound or generates a beep sound or the like, as needed.

The triaxial acceleration sensor (attitude sensor) 38 detects accelerations in three axis directions orthogonal to each other, and can determine the attitude of the projector apparatus 10 in which a projection operation is performed, by calculating the direction of the gravity acceleration from the detection output of the triaxial acceleration sensor 38.

More specifically, based on the accelerations around the projection optical axes of the projection units 22 to 27 of the projector apparatus 10, the triaxial acceleration sensor 38 detects an attitude in which the projector apparatus 10 is installed. Furthermore, trapezoid correction processing when assuming that a projection target screen surface is vertical or horizontal can be executed using an attitude angle detected by the triaxial acceleration sensor 38.

### First Operation Example

The first operation example according to the above embodiment will be described next.

Assume that it is possible to simultaneously input image signals from external apparatuses of two systems to the input processing unit 21. Images based on the input image signals have a horizontally elongated rectangular shape, similarly to a general image. If the projector apparatus 10 is used in the landscape state as a standard use method, an image projected by the projection lens unit 26 has a projection range of a horizontally elongated rectangle.

Therefore, even if image signals are input from external apparatuses of two systems to the projector apparatus 10, when the projector apparatus 10 is used in the landscape state, only a preset image signal is selected to execute a projection operation. On the other hand, when the projector apparatus 10 is used in the portrait state, a projection operation is executed using the image signals of the two systems.

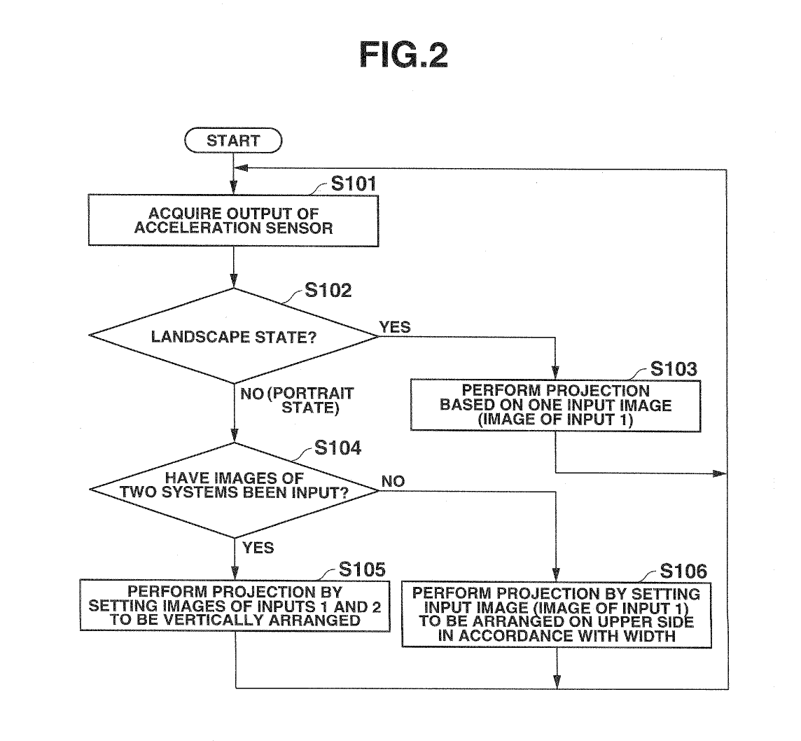

FIG. 2 is a flowchart illustrating the processing contents of a projection operation according to the attitude of the projector apparatus 10, which is executed by the CPU 33. A case in which a projection operation is performed using the projector apparatus 10 in the landscape or portrait state will be described.

Based on the accelerations around the projection optical axes of the projection units of the projector apparatus 10, the triaxial acceleration sensor 38 detects an attitude in which the projector apparatus 10 is installed. At the beginning of the processing, the CPU 33 acquires a detection output from the triaxial acceleration sensor 38 (step S101), and determines based on the acquired contents whether the projector apparatus 10 is currently in the landscape state (step S102).

If it is determined that the projector apparatus 10 is in the landscape state (YES in step S102), the

CPU (projection control unit) 33 executes, based on the current settings, the projection operation using one image signal (the image signal of input 1) input to the input processing unit 21 (step S103), and then returns to the processing in step S101.

That is, if it is determined that the attitude detected by the triaxial acceleration sensor 38 falls within a predetermined range, or the installation state of the projector apparatus 10 is the landscape state, the CPU 33 directly projects an image corresponding to the image signal (projects the image under the first projection condition). In this case, the projection range has a horizontally elongated shape.

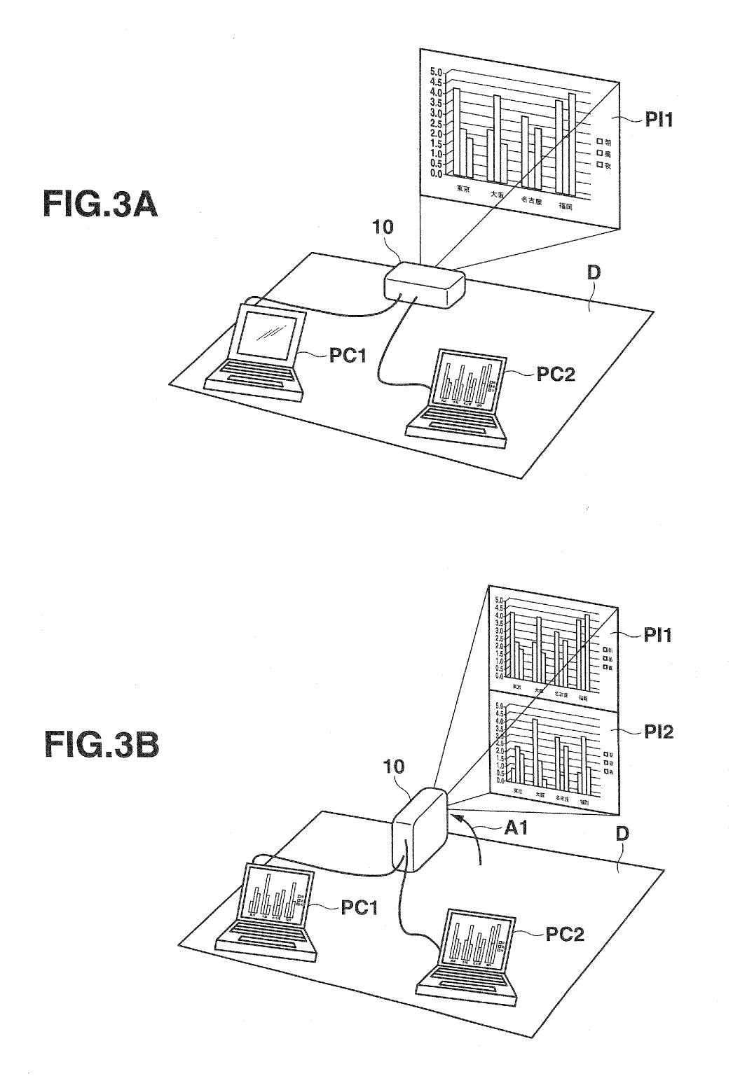

FIG. 3A shows a state in which a first personal computer PC1 and a second personal computer PC2 are connected, as two external apparatuses, to the projector apparatus 10 installed on a desk D, and input image signals to the input processing unit 21.

At this time, as shown in FIG. 3A, the projector apparatus 10 is in the landscape state on the desk D. Thus, if a setting is made to select a currently set input, for example, the image signal from the first personal computer PC1, the CPU 33 projects a projection image PI1 based on the image signal output from the first personal computer PC1 onto a screen (not shown) or the like.

If it is determined in step S102 that the projector apparatus 10 is not in the landscape state (NO in step S102), it is determined that the projector apparatus 10 is in use not in the landscape state but in the portrait state, and the CPU 33 determines whether the image signals of the two systems have simultaneously been input to the input processing unit 21 (step S104).

If it is determined that the image signals of the two systems have simultaneously been input (YES in step S104), the CPU 33 sets two images based on the image signals of the two systems to be vertically arranged in a projection range of a vertically elongated rectangle, and executes a projection operation (step S105). Then, the CPU 33 returns to the processing in step S101.

FIG. 3B shows a state in which the projector apparatus 10 installed on the desk D is raised to rotate by 90° from the state shown in FIG. 3A, as indicated by an arrow A1, and is set in the portrait state, and the first personal computer PC1 and the second personal computer PC2 are connected as two external apparatuses, and input image signals to the input processing unit 21.

Since the projector apparatus 10 is set in the portrait state, the CPU 33 projects the projection image PI1 and a projection image PI2 onto a screen (not shown) or the like based on the image signals from the first personal computer PC1 and the second personal computer PC2. In this case, a projection range has a vertically elongated shape.

If it is determined in step S104 that the image signals of the two systems have not simultaneously been input to the input processing unit 21 (NO in step S104), the CPU 33 executes a projection operation using the image signal (the image signal of input 1) of the system which has been input at this time (executes projection by setting the image of input 1 to be arranged on the upper side of the projection range in accordance with the width) (step S106), and returns to the processing in step S101.

That is, if it is determined that the attitude detected by the triaxial acceleration sensor 38 falls outside the predetermined range, or the portrait state is determined, the CPU 33 projects the image under the second projection condition different from the first projection condition instead of directly projecting the image corresponding to the image signal.

More specifically, if it is determined that the installation state of the projector apparatus 10 is the portrait state and the image signals of the two systems have been input, the two input images (of inputs 1 and 2) are vertically arranged in the projection range of the vertically elongated rectangle, and projected. If there is one input system, the input image (the image of input 1) is made to conform to the width of the projection range, arranged on the upper side of the projection range, and projected.

As described above, in the state in which the image signals of the two systems have been input to the projector apparatus 10, if an operation of simply rearranging the housing of the projector apparatus 10 from the landscape state to the portrait state is performed, horizontally elongated images corresponding to the two image signals are vertically arranged and simultaneously projected in accordance with the vertically elongated rectangle of the projection range from the projector apparatus 10. This can simultaneously project the two images by effectively using the area of the projection range without requiring complicated switching operations.

Furthermore, in the state in which the image signal of one system has been input to the projector apparatus 10, if the housing of the projector apparatus 10 is rearranged from the landscape state to the portrait state, a horizontally elongated image corresponding to one image signal is arranged on the upper side of the projection range and projected in accordance with the vertically elongated rectangle of the projection range from the projector apparatus 10. Thus, the projection image PI1 is not hidden by the shadow of the projector apparatus 10, thereby allowing a viewer to visually perceive the entire projection image PI1.

In the above first operation example, in the state in which the image signal of one system has been input to the projector apparatus 10, if the installation state changes from the landscape state to the portrait state, the input image is projected by changing the projection range from the projection range of the horizontally elongated rectangle to the projection range on the upper side of the vertically elongated rectangle, and vice versa.

That is, in the state in which the image signal of one system has been input to the projector apparatus 10, if the installation state changes from the portrait state to the landscape state, the input image is projected by changing the projection range from the projection range on the upper side of the vertically elongated rectangle to the projection range of the horizontally elongated rectangle.

In the above first operation example, a case in which the installation state of the housing of the projector apparatus 10 changes from the landscape state to the portrait state in the state wherein the image signals of two systems have been input to the projector apparatus 10 has been explained. This also applies to a case in which image signals of three or more systems are input to the projector apparatus 10.

For example, if it is determined that images of three systems have been input, the images of inputs 1, 2, and 3 are set to be arranged in three portions, that is, on the upper side of a vertically elongated rectangle, near its center, and on its lower side, and then projected.

### Second Operation Example

The second operation example according to the above embodiment will be described next.

Assume that the projector apparatus 10 is installed on, for example, the ceiling of a meeting room or the like by a mounting fitting dedicated for the projector apparatus 10, generally called a “suspension fitting”. Assume also that this suspension fitting includes a mechanical switching mechanism using a metallic spring and a shock absorber by a hydraulic damper so as to allow projection of an image on a surface such as a white board installed in the front of the meeting room by, for example, emitting image light slightly downward with respect to the horizontal direction at an arbitrarily adjusted and set depression angle while allowing projection of an image onto the desk or the like in a vertically downward direction.

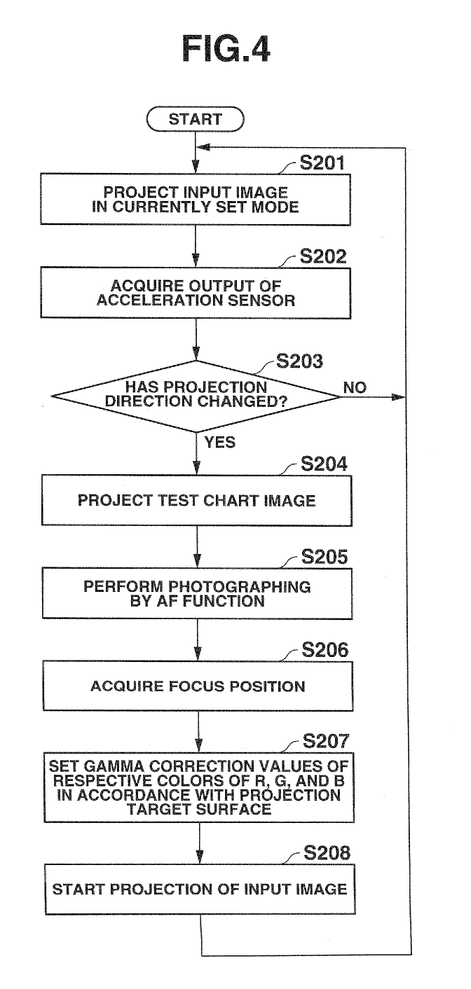

FIG. 4 is a flowchart illustrating the processing contents of a projection operation according to the attitude of the projector apparatus 10, which is executed by the CPU 33. A case in which a projection operation is performed using the projector apparatus 10 to have a projection optical axis in the almost horizontal direction or the vertically downward direction will be described.

At the beginning of the processing, the CPU 33 projects an image corresponding to an image signal input to the input processing unit 21 based on a currently set projection mode, more specifically, based on the system of an input terminal, a video signal format, brightness, a gamma correction value for gradation control for each primary color component, the presence/absence of trapezoid correction, the presence/absence of an OSD (superimposed image), and the like (step S201).

Along with this, the CPU 33 acquires a detection output from the triaxial acceleration sensor 38 (step S202), and determines, by comparing the acquired contents with contents acquired in the same step executed immediately before, whether the projection direction of the projector apparatus 10 has changed (step S203).

If it is determined that the projection direction of the projector apparatus 10 has not changed (NO in step S203), the CPU 33 returns to the processing in step S201.

By repeatedly executing the processes in steps S201 to S203, the process waits for the occurrence of a change in projection direction while maintaining the mode setting state and continuing the projection operation.

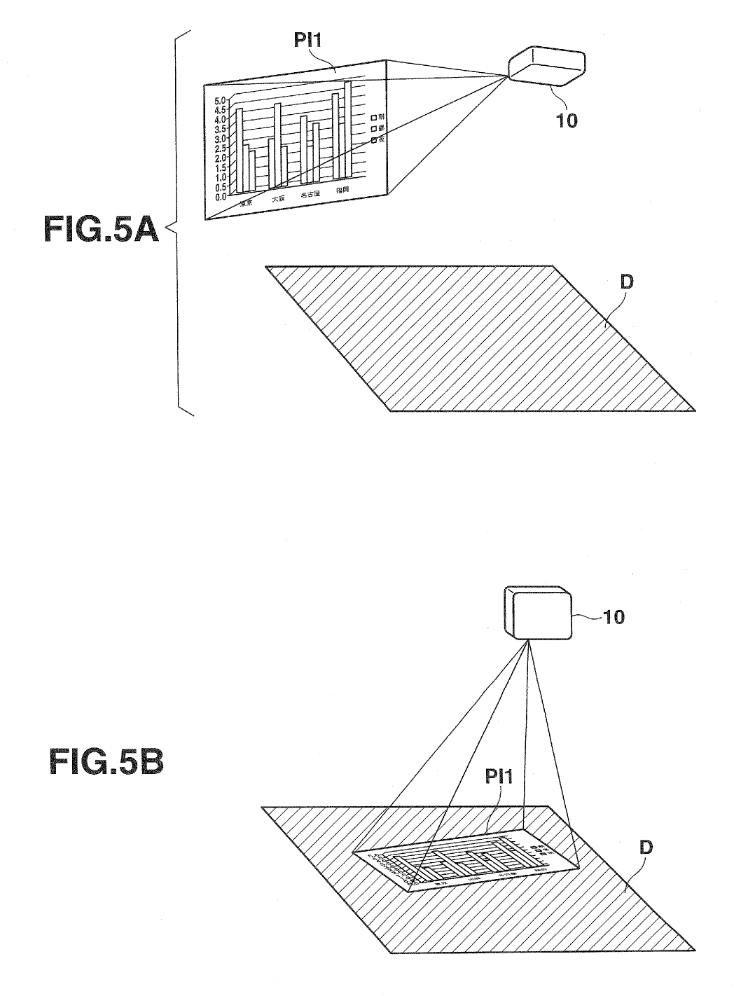

FIG. 5A shows a state in which the projector apparatus 10 emits image light along a direction set downward at a small depression angle with respect to the horizontal direction, and projects the projection image PI1 using a white board (not shown) or the like as a screen.

In, for example, image projection using a white board as a screen, the color components of a projected image hardly degrade in terms of color reproducibility due to the influence of the color of the screen surface. Thus, it is not necessary to perform color correction or the like for the image signal input to the input processing unit 21, and projection can be executed by assuming that a gamma correction value for gradation control for each primary color component is never corrected.

If it is determined in step S203 shown in FIG. 4 that the projection direction of the projector apparatus 10 is different from that last time, and has thus changed (YES in step S203), the CPU 33 reads out data of a test chart image stored in advance in the program memory 35, and temporarily projects the test chart image instead of projecting the image corresponding to the image signal from the input processing unit 21 (step S204). At this time, the CPU 33 causes the lens motor 27 to drive the focus lens in the projection lens unit 26, and projects the test chart image at a plurality of focal lengths, for example, five focal lengths from a preset shortest projection distance to a preset longest projection distance.

Along with this, the CPU 33 causes the photographic unit IM to photograph a projection image using a contrast type auto focus function (step S205).

At this time, the CPU 33 acquires, for each focal length, the position of the focus lens by the lens motor 32 when the contrast value is highest, and acquires the distance between a new projection target and the position of the focus lens at which the highest one of the highest contrast values for the respective focal lengths is obtained (step S206).

Upon acquiring the distance to the new projection target, the CPU 33 acquires the color component amounts of the projection target surface by comparing the histograms of the primary color components R, G, and B of an image photographed at the focal length when the highest contrast value is obtained with the histograms of the primary color components R, G, and B of the original test chart image, and sets the gamma correction values of the respective colors of R, G, and B of the image to be projected so as to decrease the values by the acquired color component amounts, respectively (step S207).

The CPU 33 starts the projection operation of the image input to the input processing unit 21 based on the set gamma correction values of the respective colors (step S208), and returns to the processing in step S201.

FIG. 5B exemplifies a state in which the projector apparatus 10 projects the projection image PI1 downward along the vertical direction onto the desk D by operating, in the state shown in FIG. 5A, the suspension fitting (not shown) by which the projector apparatus 10 is installed. Even if the board surface of the desk D has some color component other than white, for example, a light brown, as indicated by hatching on the desk D in FIG. 5B, image projection restarts by setting the gamma correction values so as to cancel the ground color by the above processing. Thus, it is possible to continue the projection operation with a natural tint without giving an unnatural impression to the viewer of the projection image PI1.

As described above, even if the orientation of the housing of the projector apparatus 10 is changed with respect to the projector apparatus 10, and environments such as the distance to the projection target surface and the color of the surface are changed, it is possible to continue the projection operation very naturally without any unnatural feeling.

In the projector apparatus 10 capable of performing projection in the portrait and landscape states, it is possible to automatically switch the projection condition (projection mode and input) in accordance with the orientation (the portrait or landscape state, or the like) of the projector apparatus 10.

Therefore, when an attitude detected by the attitude sensor falls within the predetermined range, an image corresponding to an image signal input by an input unit is directly projected; otherwise, the projection control unit for changing one of the image signal input by the input unit and the image quality of the image projected by the projection unit is provided.

As an example of the projection condition, if the projector apparatus 10 is set in the landscape state to perform wall projection, a brightness-oriented mode can be set as the projection mode and a TV image can be set as the input. If the projector apparatus 10 is set in the portrait state to perform ceiling projection, it is highly possible to watch an image while lying down and thus brightness is not required so much, thereby setting a theater mode (luminance-oriented) as the projection mode and a video image as the input.

If the projector apparatus 10 is set in the landscape state to perform wall projection, an image of an aquarium can be projected. If the projector apparatus 10 is set in the portrait state to perform ceiling projection, indirect illumination can be projected.

As described above, according to this embodiment, it is possible to continue an optimum projection operation in response to a change in projection environment without requiring the user to perform complicated setting operations.

In the above first operation example, a case in which the projection contents are controlled by switching the image signal input to the input processing unit 21 in accordance with the portrait/landscape state has been explained. However, by presetting contents to be switched in association with the attitude of the projector apparatus 10, the number of images to be projected, the brightness or the color priority of an image to be projected, and the like are automatically switched in accordance with the attitude of the projector apparatus 10, thereby making it possible to reduce the labor of the user.

In the above second operation example, it is possible to maintain the same image quality even if a projection target is changed, by photographing a projection target surface after the attitude of the projector apparatus 10 changes, acquiring the distance to the surface and color components, and reflecting the acquired data in a projection image after the attitude changes.

Note that in the above embodiment, the present invention has been explained by exemplifying a DLP® (Digital Light Processing) type projector. However, the present invention is not intended to limit the projection method and the like, and is equally applicable to both a transmission type liquid crystal projector and a reflection type liquid crystal projector which use a high pressure mercury vapor lamp as a light source and a color liquid crystal panel as a display element for forming an optical image.

The present invention is not limited to the embodiment described above, and can be variously modified without departing from the scope of the present invention in practical stages. The functions executed by the embodiment described above can be appropriately combined as needed and practiced. The embodiment described above incorporates various kinds of stages, and various kinds of inventions can be extracted by appropriate combinations of the plurality of disclosed constituent elements. For example, even if some constituent elements are deleted from all the constituent elements disclosed in the embodiment, an arrangement from which some constituent elements are deleted can be extracted as an invention if an effect can be obtained.

What is claimed is:

1. A projection apparatus comprising:
an input unit configured to input an image signal;
a projection unit configured to project an image corresponding to the image signal;
an attitude sensor configured to detect an attitude around a projection optical axis of the projection unit in which the projection apparatus is installed; and
a projection control unit configured to project, when the attitude detected by the attitude sensor falls within a predetermined range, the image under a first projection condition, and project, when the attitude detected by the attitude sensor falls outside the predetermined range, the image under a second projection condition different from the first projection condition.

2. The apparatus of claim 1, wherein
when the attitude falls within the predetermined range, an installation state of the projection apparatus is a landscape state and a projection range has a horizontally elongated shape, and
when the attitude falls outside the predetermined range, the installation state of the projection apparatus is a portrait state and the projection range has a vertically elongated shape.

3. The apparatus of claim 2, wherein
in image projection under the first projection condition, an input image corresponding to an image signal is directly projected, and
in image projection under the second projection condition, one of input images corresponding to image signals is arranged on an upper side of the projection range and projected.

4. The apparatus of claim 3, wherein
at the time of image projection under the second projection condition, when there are two input images, the two input images are vertically arranged in the projection range and projected.

5. The apparatus of claim 1, further comprising:
a mode selection unit configured to select, when the attitude sensor detects a change in installation attitude, a new mode setting for one of the image signal input by the input unit and image quality of the image projected by the projection unit,
wherein the projection control unit executes, based on the mode setting selected by the mode selection unit, mode setting for the image projected by the projection unit.

6. The apparatus of claim 2, further comprising:
a mode selection unit configured to select, when the attitude sensor detects a change in installation attitude, a new mode setting for one of the image signal input by the input unit and image quality of the image projected by the projection unit,
wherein the projection control unit executes, based on the mode setting selected by the mode selection unit, mode setting for the image projected by the projection unit.

7. The apparatus of claim 3, further comprising:
a mode selection unit configured to select, when the attitude sensor detects a change in installation attitude, a new mode setting for one of the image signal input by the input unit and image quality of the image projected by the projection unit,
wherein the projection control unit executes, based on the mode setting selected by the mode selection unit, mode setting for the image projected by the projection unit.

8. The apparatus of claim 4, further comprising:
a mode selection unit configured to select, when the attitude sensor detects a change in installation attitude, a new mode setting for one of the image signal input by the input unit and image quality of the image projected by the projection unit,
wherein the projection control unit executes, based on the mode setting selected by the mode selection unit, mode setting for the image projected by the projection unit.

9. The apparatus of claim 5, wherein
the mode setting newly selected by the mode selection unit includes the number of images to be projected by the projection unit and one of brightness and color priority of the image to be projected.

10. The apparatus of claim 6, wherein
the mode setting newly selected by the mode selection unit includes the number of images to be projected by the projection unit and one of brightness and color priority of the image to be projected.

11. The apparatus of claim 7, wherein
the mode setting newly selected by the mode selection unit includes the number of images to be projected by the projection unit and one of brightness and color priority of the image to be projected.

12. The apparatus of claim 8, wherein
the mode setting newly selected by the mode selection unit includes the number of images to be projected by the projection unit and one of brightness and color priority of the image to be projected.

13. The apparatus of claim 1, further comprising:
an acquisition unit configured to acquire information about a surface onto which the projection unit projects the image,
wherein the projection control unit executes, based on the information about the surface onto which the image is projected, acquired by the acquisition unit, mode setting for the image to be projected by the projection unit.

14. The apparatus of claim 2, further comprising:
an acquisition unit configured to acquire information about a surface onto which the projection unit projects the image,
wherein the projection control unit executes, based on the information about the surface onto which the image is projected, acquired by the acquisition unit, mode setting for the image to be projected by the projection unit.

15. The apparatus of claim 3, further comprising:
an acquisition unit configured to acquire information about a surface onto which the projection unit projects the image,
wherein the projection control unit executes, based on the information about the surface onto which the image is projected, acquired by the acquisition unit, mode setting for the image to be projected by the projection unit.

16. The apparatus of claim 4, further comprising:
an acquisition unit configured to acquire information about a surface onto which the projection unit projects the image,
wherein the projection control unit executes, based on the information about the surface onto which the image is projected, acquired by the acquisition unit, mode setting for the image to be projected by the projection unit.

17. The apparatus of claim 5, further comprising:
an acquisition unit configured to acquire information about a surface onto which the projection unit projects the image,
wherein the projection control unit executes, based on the information about the surface onto which the image is projected, acquired by the acquisition unit, mode setting for the image to be projected by the projection unit.

18. The apparatus of claim 9, further comprising:
an acquisition unit configured to acquire information about a surface onto which the projection unit projects the image,
wherein the projection control unit executes, based on the information about the surface onto which the image is projected, acquired by the acquisition unit, mode setting for the image to be projected by the projection unit.

19. A projection control method for a projection apparatus including an input unit configured to input an image signal and a projection unit configured to project an image corresponding to the image signal, the method comprising:
detecting an attitude around a projection optical axis of the projection unit in which the projection apparatus is installed; and
projecting, when the attitude detected in the attitude detection falls within a predetermined range, the image under a first projection condition, and projecting, when the attitude detected in the attitude detection falls outside the predetermined range, the image under a second projection condition different from the first projection condition.

20. A non-transitory computer-readable storage medium having a program stored thereon which controls a computer incorporated in a projection apparatus including an input unit configured to input an image signal and a projection unit configured to project an image corresponding to the image signal, to perform functions comprising:
an attitude sensing unit configured to detect an attitude around a projection optical axis of the projection unit in which the projection apparatus is installed; and
a projection control unit configured to project, when the attitude detected by the attitude sensor falls within a predetermined range, the image under a first projection condition, and project, when the attitude detected by the attitude sensor falls outside the predetermined range, the image under a second projection condition different from the first projection condition.
